(19) United States
(12) Patent Application Publication
(10) Pub. No.: US 2015/0094983 A1
(43) Pub. Date: Apr. 2, 2015

(54) FEATURE EXTRACTION METHOD AND APPARATUS FOR USE IN CASUAL EFFECT ANALYSIS

(71) Applicants: NEC (China) Co., Ltd., Beijing (CN); NEC Corporation, Tokyo (JP)

(72) Inventors: Hu Wang, Beijing (CN); Yuki Kosaka, Tokyo (JP)

(21) Appl. No.: 14/491,522

(22) Filed: Sep. 19, 2014

(30) Foreign Application Priority Data
Sep. 30, 2013 (CN) 201310462746.X

(51) Int. Cl. G06F 17/15; G06F 17/18

(52) U.S. Cl. CPC G06F 17/15; G06F 17/18
USPC 702/181

(57) ABSTRACT

A feature extraction method and apparatus for use in causal effect analysis, pertaining to data analysis, which includes: determining a feature time point for use in causal effect analysis on a resultant event; acquiring a predetermined number of time intervals according to the determined feature time point, where the predetermined number of time intervals are prior to the determined feature time point, and the interval length from the time interval to the determined feature time point is in positive correlation to the span of the time interval; and extracting features for use in causal effect analysis on the resultant event according to event information of potential causal events occurred in each of the time intervals. According to the present disclosure, considering the short-period and long-period potential causal event, the number of extracted features is controlled, thereby reducing the calculation workload, preventing overfitting, and improving the accuracy in causal effect analysis.

### TECHNICAL FIELD

The present disclosure relates to the field of data analysis, and in particular, to a feature extraction method and apparatus for use in causal effect analysis.

### BACKGROUND

With the development of data analysis technologies, big data is becoming increasingly eye-catching. One important objective of big data analysis is to effectively predict or control occurrence states of interested events. For the purpose of prediction or control, a causal effect analysis is desired for the events.

The causal effect means that the occurrence of one event causes direct or indirect impacts on the occurrence of another event, and in such causal effect relation, the former is a causal event and the latter is a resultant event. Typically, the causal event and the resultant event are subject to a time-based sequence. During causal effect analysis on events, potential causal events prior to the occurrence of the resultant event need to be identified, following which the causal event having a practical causal effect relation with the resultant event is determined therefrom. However, due to the large data volume, the calculation workload is very large in cases of a direct analysis. Therefore, it is desirable that features of the potential causal events are extracted such that the extracted features are applied to continue the causal effect analysis.

In the paper “Choice of multivariate autoregressive model order affecting real network functional connectivity estimate” released in Volume 120, Issue 2, Dec. 23, 2008 of Clinical Neurophysiology written by Porcaro C., Zappasodi F., Rossini P. M., and Tecchio F., a feature extraction method based on fixed time interval is proposed. The method specifically includes: acquiring potential causal events at fixed time intervals, and using occurrence states of the potential causal events as causal features of a resultant event in the time interval, to facilitate the causal effect analysis.

During the implementation of the present disclosure, the prior art has at least the following problems:

In the above featured extraction method, to ensure the accuracy of extraction, the employed fixed time interval is very small, and in cases of big data, tens of thousands of potential causal events may exist for a resultant event. In this case, if a small fixed time interval is employed for feature extraction, a large number of causal features may be extracted, which causes a high dimension of the causal feature. The causal features of high dimension may cause a greater calculation workload. As a result, the calculation in the causal effect analysis takes a long time to calculate, and the problem of overfitting may occur, such that some causal features having no causal effect on the resultant event are incorrectly associated with the resultant event under the interference of random noise, thereby increasing the error ratio of the causal effect analysis.

### SUMMARY

To address the technical problems in the prior art, embodiments of the present disclosure provide a feature extraction method and apparatus for use in causal effect analysis. The technical solutions are as follows.

In one aspect, a feature extraction method for use in causal effect analysis is provided. The method includes:

determining a feature time point for use in causal effect analysis on a resultant event;

acquiring a predetermined number of time intervals according to the determined feature time point, where the predetermined number of time intervals are prior to the determined feature time point, and the interval length from the time interval to the determined feature time point is in positive correlation to the span of the time interval; and

extracting features for use in causal effect analysis on the resultant event according to event information of potential causal events occurred in each of the time intervals.

In a second aspect, a feature extraction apparatus for use in causal effect analysis is provided. The apparatus includes:

a time point determining module, configured to determine a feature time point for use in causal effect analysis on a resultant event;

an interval acquiring module, configured to acquire a predetermined number of time intervals according to the determined feature time point, where the predetermined number of time intervals are prior to the determined feature time point, and the interval length from the time interval to the determined feature time point is in positive correlation to the span of the time interval; and

a feature extracting module, configured to extract features for use in causal effect analysis on the resultant event according to event information of potential causal events occurred in each of the time intervals.

The technical solutions provided in the embodiments of the present disclosure achieve the following beneficial effects:

According to the method and apparatus provided in the embodiments of the present disclosure, comprehensively considering the short-period potential causal event and the long-period potential causal event, the number of extracted features is controlled, thereby reducing the calculation workload, preventing the problem of overfitting, and improving the accuracy in causal effect analysis.

### BRIEF DESCRIPTION OF THE DRAWINGS

For a better understanding of the technical solutions in the embodiments of the present disclosure, the accompanying drawings illustrating the embodiments are briefly described below. The accompanying drawings in the following description illustrate only some embodiments of the present disclosure, and persons of ordinary skill in the art may derive other accompanying drawings based on these accompanying drawings without any creative effort.

FIG. 1 is a flowchart of a feature extraction method for use in causal effect analysis according to an embodiment of the present disclosure;

FIG. 2 is a flowchart of a feature extraction method for use in causal effect analysis according to an embodiment of the present disclosure;

FIG. 3 is a schematic diagram of a time interval according to an embodiment of the present disclosure;

FIG. 4 is a flowchart of a feature extraction method for use in causal effect analysis according to an embodiment of the present disclosure; and

FIG. 5 is a schematic diagram of structure of a feature extraction apparatus for use in causal effect analysis according to an embodiment of the present disclosure.

### DETAILED DESCRIPTION

The technical solutions embodied in the present disclosure are described below with reference to the embodiments and the accompanying drawings. The embodiments are exemplary only. All other embodiments obtained by persons of ordinary skill in the art, based on the embodiments of the present disclosure without creative efforts, shall fall within the protection scope of the present disclosure.

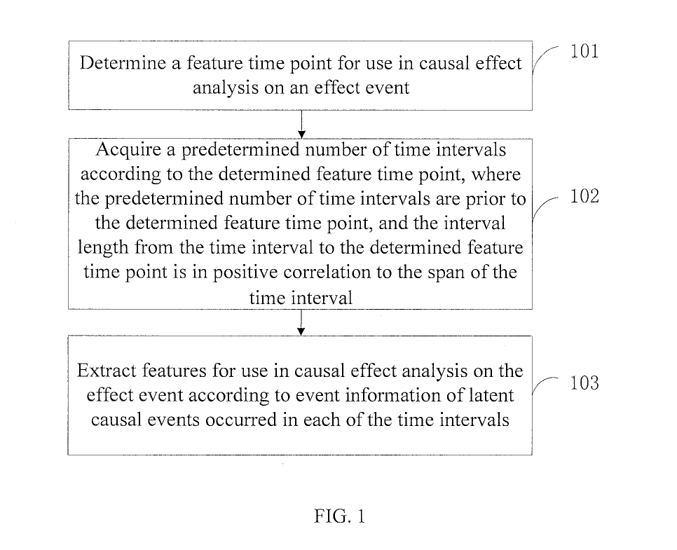

FIG. 1 is a flowchart of a feature extraction method for use in causal effect analysis according to an embodiment of the present disclosure. Referring to FIG. 1, the method includes the following steps:

Step 101: Determining a feature time point for use in causal effect analysis on a resultant event.

In this embodiment, step 101 specifically includes: in a scenario of big data, selecting a time point from time points corresponding to the mass data, and using the selected time point as the feature time point for use in causal effect analysis on the resultant event.

It should be noted that, during the causal effect analysis, the resultant event and event information of the potential causal events corresponding to the resultant event are required. The resultant event is an event in which a user is interested during the causal effect analysis. Corresponding to the resultant event, events causing direct or indirect impacts on the occurrence of the resultant event are referred to as potential causal events. The process of feature extraction refers to potential causal events that occurred before the feature time point, thus conducting a causal effect analysis on event information (for example, occurrence or non-occurrence, rise amplitude or fall amplitude) of the resultant event corresponding to the feature time point according to the extracted feature, and a causal event actually causing a causal effect on the resultant event which is determined from the potential causal events. In practice, a plurality of feature time points may be determined such that event information of the resultant events corresponding to the plurality of feature time points is acquired. In this way, the causal effect analysis is conducted according to the feature extracted at different feature time points, and the event information of the resultant events corresponding to different feature time points, to acquire a more accurate relation model.

It should be noted that, with respect to the data to be analyzed during the causal effect analysis, the data is recorded according to the time point when the event occurs, and archived in a time sequence data form. The time point is a basic unit of the time sequence data. That is, when the feature time point is determined, event information of the resultant event corresponding to the feature time point is acquired from the database.

However, depending on the type, the resultant event may be determined according to the occurrence state or according to numeric value information, which are respectively referred to as a first resultant event and a second resultant event. The occurrence state of the first resultant event is “occurred” or “not occurred”, that is, the resultant event may have occurred or may not have occurred. The second resultant event may be numeric value information of the resultant event, that is, the resultant event may be represented in the form of the numeric value information. Alternatively, the second resultant event may also be an event whose occurrence state is determined as “occurred” when the numeric value information satisfies a predetermined rule, and may also be an event whose occurrence state is determined as “not occurred” when the numeric value information does not satisfy the predetermined rule. That is, the occurrence state of the resultant event may be determined according to whether the numeric value information satisfies the predetermined rule, and is finally indicated by “occurred” or “not occurred”. To be specific, when the numeric value information of the second resultant event exceeds a predetermined threshold, it is determined that the second resultant event has occurred. Likewise, when a rise proportion of the numeric value information of the second resultant event exceeds a predetermined percentage, it is determined that the second resultant event has occurred.

It should be noted that, to improve accuracy in the subsequent causal effect analysis, all recorded event information of the resultant event needs to be analyzed. To be specific, the resultant event may be indicated as “occurred” or “not occurred”. A feature extraction may be performed for the resultant event according to the feature time point. The resultant event is then indicated using numeric value information, a time point is determined for each of the numeric value information, and then feature extraction is performed according to the feature time point such that an accurate relation model is established by using a machine learning method.

For example, consider that events, including tough weather conditions, changes in economic policies, pollution levels, and comments in web forums, may cause the rise of crime rate in cities. As such, the weather conditions, the changes in economic policies, the pollution levels, and the number of comments in web forums, are used as potential causal events. The event of the rise of crime rate in cities is used as a resultant event. A feature time point for feature extraction is selected, and a feature extraction is performed according to the feature time point. The crime rate in cities is then used as the resultant event, and the feature extraction is performed according to the crime rate in cities corresponding to the feature time point and the crime rate in cities corresponding to each of the time points recorded before the feature time point.

Step 102: Acquiring a predetermined number of time intervals according to the determined feature time point, where the predetermined number of time intervals are prior to the determined feature time point, and the interval length from the time interval to the determined feature time point is in positive correlation to the span of the time interval.

The predetermined number may be defined by a data analyst during a requirement analysis, or determined according to the distribution of the occurred events, which are not limited in this embodiment. In addition, the span of each time interval may be determined according to a function or the distribution of the occurred events, which are not limited in this embodiment.

For example, during an economic crisis, when various types of causal events frequently occur, a larger predetermined number and a smaller time interval span may be defined. However, during economic prosperity, when various types of causal events seldom occur, a small predetermined number and a larger time interval span may be defined.

During the causal effect analysis, the causal events definitely occur before the resultant event. Therefore, during the feature extraction, the feature time point of the resultant event is taken as an end time point, and at least one time interval before the feature time point and potential causal events occurred in each of the at least one time interval are acquired. The impact caused by the causal events on the resultant event is embodied after a specific latent period. Some causal events have a long latent period while some have a short latent period. Therefore, the causal events having a short latent period are generally distributed within a history period close to the feature time point in a high density, and the causal events having a long latent period are generally distributed within a history period far from the feature time point in a low density. The resultant event may be subject to various types of causal events, thus, features of various types of causal events need to be extracted. Therefore, during the division of time intervals, different time intervals need to be employed in an integral consideration of accuracy and calculation workload during the feature extraction.

Preferably, an interval length from the time interval to the feature time point is in positive correlation with the span. That is, the closer the time interval is to the feature point, the smaller the interval length is and the smaller the span is. As the time interval becomes further and further away from the feature time point, the span of the time interval becomes larger and larger. Determining the span of the time interval according to the positive correlation with the interval length can effectively control the number of features. That is, with respect to causal events having a short latent period, since such causal events are generally distributed within a history period close to the feature time point in a high density, a smaller span should be employed for the time interval closer to the feature time point, thereby extracting more features and thus improving the accuracy in feature extraction. With respect to causal events having a long latent period, since such causal events are generally distributed within a history period far from the feature time point in a low density, a larger span should be employed for the time interval further from the feature time point, thereby controlling the number of features of the causal events having a long latent period, and thus reducing the calculation workload.

The following steps using feature extraction for one type of potential causal event of the resultant event is illustrated as an example. In practice, features of each of various types of potential causal events may be separately extracted for use in causal effect analysis on the resultant event according to the acquired time intervals, thereby extracting the features for use in causal effect analysis on the resultant event.

Step 103: Extracting features for use in causal effect analysis on the resultant event according to event information of potential causal events occurred in each of the time intervals.

In this embodiment, step 103 specifically includes 1031 and 1032.

1031: Acquiring statistical information of the potential causal events occurred in each of the time intervals according to the event information of the potential causal events occurred in each of the time intervals.

Specifically, in a scenario of big data, when each of the time intervals is determined, potential causal events occurred in each of the time intervals are determined according to each of the time intervals and present types of potential causal events. After the potential causal events are determined, the event information of the potential causal events occurred in each of the time intervals is acquired, and statistical collection is conducted for the event information of the potential causal events occurred in each of the time intervals, and the statistical information in each of the time intervals is acquired.

The types of the potential causal events may be predefined by a data analyst. For example, based on the example in step 101, a user may define events pertaining to the type of economic policy change as the potential causal events. When any are economic policies changes, the event regarding the economic policy change is determined as the potential causal event.

The event information may be the occurrence state of a potential causal event, i.e., “occurred” or “not occurred”. The occurrence state may be indicated in a binary manner. When the potential causal event has occurred, the event information of the potential causal event is one (1). When the potential causal event has not occurred, the event information of the potential causal event is zero (0). In addition, the event information may also be numeric value information of the potential causal event. For instance, taking weather conditions as an example, the event information of the weather conditions may be such numeric value information as 38° C. or 40° C.

In this embodiment, when the event information is the occurrence state of a potential causal event, the statistical information of the potential causal events occurred in each of the time intervals may be an occurrence frequency of the potential causal events occurred in each of the time intervals; or when the event information is the numeric value information of a potential causal event, the statistic information of the potential causal events occurred in each of the time intervals may be an occurrence frequency, an average value of the numeric value information, a standard deviation of the numeric value information, and the like, of the potential causal events occurred in each of the time intervals, where a specific form of the statistical information may be predefined by a data analyst, which is not limited in this embodiment.

1032: Extracting the features for use in causal effect analysis on the resultant event according to the statistical information of the potential causal events occurred in each of the time intervals.

In embodiments of the present disclosure, step 1032 specifically includes step (1) or step (2).

(1) Extracting the statistical information of the potential causal event occurred in each of the time intervals as the features for use in causal effect analysis on the resultant event.

(2) Combining the statistical information of the potential causal events occurred in each of the time intervals, and extracting the combined information as the features for use in causal effect analysis on the resultant event.

The statistical information may be combined in a manner described in (2-1) or (2-2).

(2-1) Using each type of potential causal events as a row of a matrix, and using each time interval as a column of the matrix; combining the statistical information, and extracting an acquired statistical information matrix as a feature matrix for use in causal effect analysis on the resultant event.

In this embodiment, with respect to each type of potential causal events of the resultant event, statistical information corresponding to each of the time intervals may be acquired, i.e., acquiring a multi-dimensional feature, including a potential causal event dimension and a time interval dimension. In this case, each type of potential causal events are used as a row of the matrix, and each of the time intervals are used as a column of the matrix, the statistical information for each type of potential causal events occurred in each of the time intervals is combined, and an acquired statistical information matrix is extracted as a feature matrix for use in causal effect analysis on the resultant event.

(2-2) Combining the statistical information of each type of potential causal events in each of the time intervals in the order of the type of the potential causal events, and extracting an acquired vector as a feature vector for use in causal effect analysis for the resultant event.

In this embodiment, each type of potential causal events may be sequenced, and the statistical information of each type of the potential causal events in each of the time intervals may be sequentially arranged in the order of the type of the potential causal events. A statistical information vector is thus acquired by combination, and the acquired statistical information vector is extracted as the feature vector for use in causal effect analysis on the resultant event. The sequence of the potential causal events is not unique, and may vary according to analysis requirements.

In practice, the statistical information may be combined in other manners, which is not limited in this embodiment.

In this embodiment, after step 103, the extracted features and the event information of the resultant event are used as a sample, and a relation model between each type of potential causal events and the resultant event is established by means of machine learning (for example, logistic regression of norm regularization). With respect to the potential causal events whose coefficients in the relation model are positive, based on relevant knowledge of a person skilled in the art, a causal event which is actually in a cause-effect relation with the resultant event is further determined from the potential causal events.

According to the method provided in this embodiment, time intervals having different spans are acquired, statistical information of each of the time intervals is acquired, the statistical information of each of the time intervals is extracted as a feature for use in causal effect analysis, such that, comprehensively considering the short-period potential causal event and the long-period potential causal event, the number of extracted features is controlled, thereby reducing the calculation workload, preventing the problem of overfitting, and improving the accuracy in causal effect analysis.

Optionally, based on the technical solution disclosed in the embodiment illustrated in FIG. 1, step 102 “acquiring a predetermined number of time intervals according to the determined feature time point” includes steps 1021, 1022, 1023, and 1024:

1021: Acquiring, according to a time span for use in causal effect analysis, a time interval function corresponding to the time span for use in causal effect analysis.

The time span for use in causal effect analysis refers to a total time span for use in causal effect analysis, which is determined according to analysis requirements. For example, if causal events have occurred within two years before the resultant event and caused direct or indirect impacts on the resultant event needed to be found, the time span for use in causal effect analysis is determined as two (2) years.

The time interval function varies with the time span for use in causal effect analysis. Optionally, when the time span for use in causal effect analysis is small, a function having a small growth is acquired as the time interval function; when the time span for use in causal effect is large, a function having a large growth is acquired as the time interval function. For example, if the event information of the potential causal events is recorded in the unit of day, when the time span for use in causal effect analysis is one (1) month, the time interval function may be a proportional function, and when the time span for use in causal effect analysis is one (1) year, the time interval function may be an exponential function. A correspondence relationship between the time span for use in causal effect analysis and the time interval function may be defined according to an expected value of the latent period of a short-term potential causal event and an expected value of the latent period of a long-term potential causal event, which is not limited in this embodiment.

Preferably, the argument and function value of the time interval function are integers, and the time interval function is an increasing function such that the time interval span determined according to the time interval function satisfies the following condition: the longer the interval length from the time interval to the feature time point, the larger the span of the time interval. For example, an exponential function is acquired as the time interval function, or a Fibonacci sequence function, is acquired as the time interval function.

For example, if the event information of the potential causal events is recorded by month and the time span for use in causal effect analysis is three (3) years, the time interval function may be exponential function f(i)=3ⁱ⁻¹, where i denotes a sequence number of the time interval, and f(i) denotes a span of the time interval.

1022: Determining a span of each of the time intervals according to the time interval function.

In this embodiment, the time interval function is used to determine the span of each of the time intervals. Specifically, the argument of the time interval function may be the sequence number of the time interval function, where the function value is the span of the time interval. Alternatively, the argument of the time interval function may be a start point of the time interval, where the function value is the span of the time interval. This embodiment sets no limitation to the argument of the time interval function.

Correspondingly, when the argument of the time interval function is the sequence number of the time interval, the span of each of the time intervals is determined in order, from small to large, of the sequence numbers, according to the time interval function and the sequence number of the time interval. Alternatively, when the argument of the time interval function is the start point of the time interval, after a previous time interval is determined, the end point of the previous time interval is determined as the start point of a time interval. The span of the time interval is determined according to the start point of the time interval and the time interval function, the end point of the time interval is determined according to the start point and span of the time interval. In this way, the time interval is eventually determined.

1023: Using the determined feature time point as a start point of a first time interval of the predetermined number of time intervals; and determining an end point of the first time interval according to the span and the start point of the first time interval.

1024: Determining start points and end points of other time intervals of the predetermined number of time intervals according to the determined end point of the first time interval and spans of the other time intervals of the predetermined number of time intervals.

Specifically, starting from the first time interval, the end point of the time interval is determined as the start point of a time interval. The end point of the time interval is determined according to the start point and span of the time interval, and the time interval is determined as the determined time interval. A next time interval is analogously determined until the number of determined time interval reaches the predetermined number.

Based on the example in step 1021, the predetermined number is four (4), and the time interval function is f(i)=3ⁱ⁻¹. In this case, the spans of the four time intervals are determined as 1 month, 3 months, 9 months, and 27 months. Starting from the feature time point as the zero point, along a reverse direction of the progress of the time, the time intervals having spans of 1 month, 3 months, 9 months, and 27 months are sequentially acquired. To be specific, it is determined that the start point of the first time interval is zero (0) and the end point thereof is 1 (month), the start point of the second time interval is 1 (month) and the end point thereof is 4 (months), the start point of the third time interval is 4 (months) and the end point thereof is 19 (months), and the start point of the fourth time interval is 13 (months) and the end time point is 40 (months). In this case, the number of time intervals reaches the predetermined number four (4), and therefore acquisition of the time interval is terminated.

It should be noted that, since the total span of the time intervals determined according to the time interval function and the predetermined number may be unequal to the time span for use in causal effect analysis, the divided time intervals may be adjusted according to the time span for use in causal effect analysis, for example, adjusting the span of the last time interval. For instance, if the time span for use in causal effect analysis is forty-five (45) months, and the spans of the four time intervals determined according to the time interval function and predetermined number are 1 month, 3 months, 9 months, and 27 months, the total span is 40 months, which is smaller than the time span for use in causal effect analysis. In this case, the time interval having the span of twenty-seven (27) months may be extended to a span of thirty-two (32) months. This embodiment sets no limitation to the method for such adjustment of the span.

Optionally, based on the technical solution disclosed in the embodiment illustrated in FIG. 1, step 1031 “acquiring statistical information of the potential causal events occurred in each of the time intervals according to the event information of the potential causal events occurred in each of the time intervals” includes: with respect to a time interval, calculating an occurrence frequency of potential causal events in the time interval, and using the occurrence frequency as statistical information of the potential causal events occurred in the time interval.

In this embodiment, when event information of a potential causal event is an occurrence state of the potential causal event, the statistical information may be an occurrence frequency of the event. Specifically, when the potential causal event has occurred, the event information thereof is one (1), and when the potential causal event has not occurred, the event information thereof is zero (0). With respect to a time interval, a sum of the event information of the potential causal events occurred in the time interval is the number of occurrences of the potential causal events occurred in the time interval. According to the number of occurrences and the span of the time interval, an occurrence frequency of the potential causal event in the time interval is calculated, and the calculated occurrence frequency is used as the statistical information of the potential causal event occurred in the time interval.

For example, with respect to a time interval having a span of three (3) days, if it is determined, according to event information of potential causal events, that an economic policy change event has occurred twice during the time interval, the occurrence frequency of the economic policy change event in the time interval is ⅔.

Further, with respect to each of the time intervals, according to the sum of event information of potential causal events occurred in each of the time intervals and the span of each time interval, the occurrence frequency of the potential causal events in each of the time intervals is calculated, and the calculated occurrence frequency in each of the time intervals is used as the statistical information of the potential causal events occurred in each of the time intervals.

Optionally, based on the technical solution disclosed in the embodiment illustrated in FIG. 1, step 1031 “acquiring statistical information of the potential causal events occurred in each of the time intervals according to the event information of the potential causal events occurred in each of the time intervals” includes: with respect to a time interval, calculating an average value of the event information of potential causal events in the time interval, and using the calculated average value as statistical information of the potential causal events occurred in the time interval.

In this embodiment, when event information of a potential causal event is the numeric value information of the potential causal event, the statistical information may be an average value of the event information. Specifically, with respect to a time interval, a sum of event information of potential causal events occurred in the time interval is calculated, the calculated sum is divided by the span of the time interval to acquire an average of the event information of the potential causal events in the time interval, and the average value is used as the statistical information of the potential causal events occurred in the time interval.

For example, the numeric value information of the potential causal event, i.e., the weather condition, is atmospheric temperature. With respect to a time interval having a span of three (3) days, if the atmospheric temperatures collected in the time interval are respectively 35° C., 37° C., and 36° C., it is calculated that the average value of the atmospheric temperatures in the time interval is 36° C., and statistical information of the atmospheric temperature in the time interval is 36° C.

Further, with respect to each of the time intervals, according to the sum of event information of potential causal events occurred in each of the time intervals and the span of each of the time intervals, the average value of the event information of the potential causal events in each of the time intervals is calculated, and the calculated average value in each of the time intervals is used as the statistical information of the potential causal events occurred in each of the time intervals.

Optionally, based on the technical solution disclosed in the embodiment illustrated in FIG. 1, step 1031 “acquiring statistical information of the potential causal events occurred in each of the time intervals according to the event information of the potential causal events occurred in each of the time intervals” includes: with respect to a time interval, calculating a standard deviation of the event information of potential causal events in the time interval, and using the calculated standard deviation as statistical information of the potential causal events occurred in the time interval.

In this embodiment, when event information of a potential causal event is numeric value information of the potential causal event, the statistical information may be a standard deviation of the event information. Specifically, with respect to a time interval, an average value of event information of potential causal events occurred in the time interval is calculated, and a standard deviation of the event information of the potential causal events occurred in the time interval is calculated by using a standard deviation formula according to the event information of the potential causal events occurred in the time interval and the average value of the event information. The calculated standard deviation is used as the statistical information of the potential causal events occurred in the time interval.

Still taking the atmospheric temperature in the time interval as an example, if the atmospheric temperatures in the time interval are respectively 35° C., 37° C., and 36° C. and the average value is 36° C., it is calculated that the standard deviation of the atmospheric temperatures in the time interval is 1.41, and the statistical information of the atmospheric temperatures in the time interval is 1.41.

Further, with respect to each of the time intervals, according to the sum of event information of potential causal events occurred in each of the time intervals, the average value of the event information of the potential causal events in each of the time intervals is calculated, and then the standard deviation of the event information of the potential causal events occurred in each of the time intervals is calculated. The calculated standard deviation in each of the time intervals is used as the statistical information of the potential causal events occurred in each of the time intervals.

It should be noted that the statistical information is not limited to the above-described occurrence frequency, average value, and standard deviation. Instead, the statistical information may also be such information as a variance, which is not limited in this embodiment.

Optionally, based on the technical solution disclosed in the embodiment illustrated in FIG. 1, step 1031 “acquiring statistical information of the potential causal events occurred in each of the time intervals according to the event information of the potential causal events occurred in each of the time intervals” includes steps 1031-1, 1301-2, 1031-3, 1031-4, 1031-5, and 1031-6.

1031-1: With respect to a time interval, using the time interval as a first time interval, and using a neighbor time interval as a second time interval.

In this embodiment, either of the two neighbor time intervals of the first time interval may be used as the second time interval, which is not limited in this embodiment.

1031-2: Determining a weight, in the first time interval, of each of the potential causal events occurred in the first time interval according to a weight function.

The weight function is used to allocate weights for the potential causal events. The argument of the weight function may be a time point, and the function value thereof may thus be the weight of a potential causal event occurred at the time point.

In this embodiment, a border effect may be caused between two neighbor time intervals. The border effect means that if an event has occurred in the vicinity of the border point of two neighbor time intervals, the event may cause some impacts on the neighbor time intervals. In this case, during a calculation of the statistical information, the calculation may be performed according to the impacts caused by the event to the two neighbor time intervals, such that the extracted features are not subject to the random noise.

To prevent the border effect, a weight may be allocated to each of the potential causal events occurred in the two neighbor time intervals, such that during a calculation of the event information of the potential causal events occurred in the time intervals, the potential causal events occurred in the vicinity of the border point of the neighbor time intervals are separately contributed to the two neighbor time intervals according to the weights thereof.

1031-3: With respect to the second time interval, determining a weight, in the first time interval, of each of the potential causal events occurred in the second time interval according to the weight function.

Specifically, the weight, in the first time interval, of each of the potential causal events occurred in the second time interval, may be determined according to the weight function.

Optionally, according to the weight function, the weight (larger than or equal to zero and smaller than one) in the second time interval of a potential causal event occurred in the second time interval, and in the vicinity of the border point of the first time interval and the second time interval, is determined. A difference between one (1) and the weight is used as the weight, in the first time interval, of a potential causal event occurred in the second time interval.

For example, with respect to two neighbor time intervals 1 and 2, a foreign trading policy change event has occurred in the vicinity of the border points of the two neighbor time intervals 1 and 2 and in the time interval 1, and a national financial policy change event has occurred in the vicinity of the border points of the two neighbor time intervals 1 and 2 and in the time interval 2, and both of these two events pertain to economic policy change events. In this case, if it is determined, according to the weight function, that the weight of the foreign trading policy change event in the time interval 1 is 0.6, it can be determined that the weight of the foreign trading policy change event in the time interval 2 is 0.4. If it is determined, according to the weight function, that the weight of the national financial policy change event in the time interval 2 is 0.7, it can be determined the national financial policy change event in the time interval 1 is 0.3.

1031-4: Performing a weight calculation to acquire first adjustment event information of each of the potential causal events occurred in the time interval according to the event information of each of the potential causal events occurred in the first time interval and the weight, in the first time interval, of each of the potential causal events occurred in the first time interval.

Specifically, a product is calculated by multiplying the event information of each of the potential causal events occurred in the first time interval by the weight, in the first time interval, of each of the potential causal events occurred in the first time interval. The calculated product is acquired as first adjustment event information of each of the potential causal events occurred in the time interval.

1031-5: Performing a weight calculation to acquire second adjustment event information, in the first time interval, of each of the potential causal events occurred in the second time interval according to the event information of each of the potential causal events occurred in the second time interval and the weight, in the first time interval, of each of the potential causal events occurred in the second time interval.

Specifically, a product is calculated by multiplying the event information of each of the potential causal events occurred in the second time interval by the weight, in the first time interval, of each of the potential causal events occurred in the second time interval. The calculated product is acquired as the second adjustment event information, in the first time interval, of each of the potential causal events occurred in the second time interval.

1031-6: Acquiring the statistical information of the potential causal events occurred in the first time interval according to the first adjustment event information of each of the potential causal events occurred in the first time interval and the second adjustment event information, in the first time interval, of each of the potential causal events occurred in the second time interval.

In this embodiment, step 1031-6 specifically includes:

(3) According to the first adjustment event information and the second adjustment event information, calculating a redefinition frequency of each of the potential causal events occurred in the first time interval, and using the redefinition frequency as the statistical information of the potential causal events occurred in the first time interval.

In this embodiment, when event information of a potential causal event is an occurrence state of the potential causal event, the statistical information may be a redefinition frequency of the event. The redefinition frequency is used to indicate a proportion of the sum of contribution of each of the potential causal events occurred in the first time interval to the first time interval, and of each of the potential causal events occurred in the second time interval to the first time interval, after being weighted, to the span of the first time interval. Specifically, the first adjustment event information and the second adjustment event information are added, and the result is divided by the span of the first time interval, so as to obtain the redefinition frequency of each of the potential causal events occurred in the first time interval. The redefinition frequencies are used as the statistical information of the potential causal events occurred in the first time interval.

For example, with respect to a first time interval having a span of three (3) days, if an economic policy change event has occurred for two times in the first time interval, where the weight of the first occurred economic policy change event is 0.6 and the weight of the second occurred economic policy change event is 1, then the first adjustment event information is respectively 0.6 and 1; if an economic policy change event has occurred twice in the second time interval, where the weight of the first occurred economic policy change event in the first time interval is 0.3 and the weight of the second occurred economic policy change event in the first time interval is 0, then the second adjustment event information is respectively 0.3 and 0. In this case, the occurrence frequency of the economic policy change event in the first time interval is (0.6+1+0.3+0)/3=0.633.

Further, with respect to each of the first time intervals, redefinition frequencies of potential causal events occurred in each of the first time intervals are calculated according to the first adjustment event information of the potential causal events occurred in each of the first time intervals, the second adjustment information, in each of the first time intervals, of the potential causal events occurred in the second time interval, and the span of each of the first time intervals. The redefinition frequencies for each of the first time intervals are used as the statistical information of the potential causal events occurred in each of the first time intervals.

(4) Calculating an average value of the first adjustment event information of each of the potential causal events occurred in the first time interval and the second adjustment event information, in the first time interval of each of the potential causal events occurred in the second time interval, and using the calculated average value as the statistical information of the potential causal events occurred in the first time interval.

In this embodiment, when event information of a potential causal event is numeric value information of the potential causal event, the statistical information may be an average value of the adjustment event information. Specifically, a sum of the first adjustment event information of the potential causal events occurred in the first time interval and the second adjustment event information, in the first time interval, of the potential causal events occurred in the second time interval is calculated. The sum is divided by the span of the first time interval to acquire an average value of the adjustment event information of the potential causal events in the first time interval, and the average value is used as the statistical information of the potential causal events occurred in the first time interval.

For example, the numeric value information of the potential causal event, i.e., the weather condition, is atmospheric temperature. With respect to a first time interval having a span of three (3) days, if the atmospheric temperatures collected in the first time interval are respectively 35° C., 37° C., and 36° C., and the weights of the collected atmospheric temperatures in the first time interval are respectively 0.8, 1, and 1, then the first adjustment event information is respectively 28° C., 37° C., and 36° C. If the atmospheric temperatures collected in the second time interval are respectively 35° C. and 36° C., and the weights of the atmospheric temperatures collected in the second time interval in the first time interval are respectively 0.4 and 0, then the second adjustment event information is respectively 14° C. and 0° C. In this case, the statistical information of the atmospheric temperatures in the first time interval is (28+37+36+14+0)/3=38.33° C.

(5) Calculating a standard deviation of the first adjustment event information of each of the potential causal events occurred in the first time interval and the second adjustment event information, in the first time interval, of each of the potential causal events occurred in the second time interval, and using the calculated standard deviation as the statistical information of the potential causal events occurred in the first time interval.

In this embodiment, when event information of a potential causal event is numeric value information of the potential causal event, the statistical information may be a standard deviation of the event information. Specifically, an average value of the first adjustment event information of the potential causal events occurred in the first time interval and the second adjustment event information, in the first time interval, of the potential causal events occurred in the second time interval is calculated. A standard deviation of the first adjustment event information of each of the potential causal events occurred in the first time interval and the second adjustment event information, in the first time interval, of each of the potential causal events occurred in the second time interval is calculated by using a standard deviation formula. The calculated standard deviation is used as the statistical information of the potential causal events occurred in the first time interval.

It should be noted that the statistical information is not limited to the above-described occurrence frequency, average value, and standard deviation. Instead, the statistical information may also be such information as a variance, which is not limited in this embodiment.

It should be noted that the first time interval may have two neighbor time intervals, i.e., a first neighbor time interval and a second neighbor time interval. In this case, in another embodiment of the present disclosure, step 1031-3 includes: with respect to the first neighbor time interval of the first time interval, determining, according to the weight function, the weight, in the first time interval, of each of potential causal events occurred in the first neighbor time interval. With respect to the second neighbor time interval of the first time interval, determining, according to the weight function, the weight, in the first time interval, of each of potential causal events occurred in the second neighbor time interval. Correspondingly, step 1031-3 includes: according to the event information of each of the potential causal events occurred in the first time interval and the weight, in the first time interval, of each of the potential causal events occurred in the first time interval, performing weight calculation to acquire first adjustment event information of each of the potential causal events occurred in the time interval. Step 1031-5 includes: according to the event information of each of the potential causal events occurred in the first neighbor time interval and the weight, in the first time interval, of each of the potential causal events occurred in the first neighbor time interval, performing weight calculation to acquire second adjustment event information, in the first time interval, of each of the potential causal events occurred in the first neighbor time interval. According to the event information of each of the potential causal events occurred in the second neighbor time interval and the weight, in the first time interval, of each of the potential causal events occurred in the second neighbor time interval, performing weight calculation to acquire third adjustment event information, in the first time interval, of each of the potential causal events occurred in the second neighbor time interval. Step 1031-6 includes: acquiring the statistical information of the potential causal events occurred in the first time interval according to the first adjustment event information of each of the potential causal events occurred in the first time interval, the second adjustment event information, in the first time interval, of each of the potential causal events occurred in the first neighbor time interval, and the third adjustment event information, in the first time interval, of each of the potential causal events occurred in the second neighbor time interval.

Optionally, based on the technical solution disclosed in the embodiment illustrated in FIG. 1, the method further includes steps (6), (7), and (8).

(6) According to the span of each of the time intervals, setting a weight for a middle point of a time interval with a shorter time span between every two neighbor time intervals, and a weight for a border point of every two neighbor time intervals.

Specifically, with respect to two neighbor time intervals, according to the span of the two neighbor time intervals, the weight at the middle point of the time interval having a smaller span is set, and the weight at the border point of the two neighbor time intervals is set.

Preferably, the weight at the middle point is set to 1. Further preferably, the weight at the border point is set to 0.5. The closer the time points of the potential causal events occurred in both the first time interval and die second time interval are to the border point, the smaller the weights of the potential causal events are.

To specify further, the feature time point is used as zero point, and a time point determined using a direction reverse to the progress of the time as the X coordinate is used as the argument of the weight function. In this case, with respect to a first time interval and a corresponding second time interval, a border point t1 of the first time interval and the second time interval, and a span f(i) of the first time interval and a span f+1) of the second time interval, are acquired. In the spans, i denotes a sequence number of the time interval, the second time interval is prior to the first time interval, and f(i) is smaller than f(i+1). In this case, preferably the weight of a time point t1−f(i)/2 is set to 1, and the weight of the time point t1 is set to 0.5.

(7) Acquiring a weight function corresponding to each of the time intervals according to the middle point, the border point, the weight of the middle point, and the weight of the border point.

Specifically, when the weight at the middle point of a time interval having a smaller span in every two neighbor time intervals is set, the weight of the middle point of each of the time intervals except the one having the maximum span is determined. When the weight at the border of the two neighbor time intervals is set, the weight of each of the border points is determined. In this case, a linear interpolation is performed in a time interval between the middle point and the border point of each of the time intervals, according to the weight of the middle point of each of the time intervals and the weight of each of the border points, thereby acquiring a weight function corresponding to each of the time intervals.

For example, according to the time point t1−f(i)/2, the time point t1, the weight of the time point t1−f(i)/2, and the weight of the time point t1, a linear interpolation is performed in a time interval (t1−f(i)/2, t1) to acquire a weight function corresponding to the time interval (t1−f(i)/2, t1).

It should be noted that, to ensure that the weights of the potential causal events occurred at the time points symmetric with respect to the border point in two neighbor time intervals are equal, the weight for a symmetric point of the middle point in a time interval having a larger span may be set to be equal to the weight at the middle point. According to the symmetric point, the border point, the weight at the symmetric point, and the weight at the border point, a linear interpolation is performed in a time interval between the symmetric point and the border point to acquire a weight function corresponding to the time interval between the symmetric point and the border point.

Further description is given by further using the above example. The symmetric point of the time point t1−f(i)/2 to the time point t1 is t1+f(i)/2. The weight of the time point t1+f(i)/2 is also set to 1. According to the time point t1+f(i)/2, the time point t1, the weight of the time point t1+f(i)/2, and the weight of the time point t1, a linear interpolation is performed in a time interval (t1, t1+f(i)/2) to acquire a weight function corresponding to the time interval (t1, t1+f(i)/2).

Correspondingly, step (4) includes: performing a linear interpolation in a time interval between the middle point, the symmetric point and the border point of each of the time intervals, according to the weight at the middle point, the weight at the symmetric point, and the weight at the border point of each of the time intervals, thereby acquiring a weight function corresponding to each of the time intervals.

(8) Combining the weight functions corresponding to the time intervals, and determining the combination as the weight function.

Specifically, when the weight function corresponding to each of the time intervals is determined, the weight functions corresponding to the time intervals are combined in a time sequence, such that all of the weight functions corresponding to the time intervals are combined into one weight function, that is, the weight function described above.

Optionally, based on the technical solution disclosed in the embodiment illustrated in FIG. 1, prior to step 102 “acquiring a predetermined number of time intervals according to the determined feature time point”, the method further includes: determining the predetermined number according to feature representation capability and system calculation speed.

During the analysis of big data, the more the extracted features are, the stronger the feature representation capability is. However, a large number of features may cause a long calculation duration. Therefore, in this embodiment, the predetermined number may be determined by comprehensively considering the feature representation capability and the system calculation speed for casual effect analysis. Preferably, the predetermined number is from three (3) to five (5).

According to the method provided in this embodiment, time intervals having different spans are acquired, statistical information of each of the time intervals is acquired, the statistical information of the each of the time intervals is extracted as a feature for use in the causal effect analysis, such that, comprehensively considering the short-period potential causal event and the long-period potential causal event, the number of extracted features is controlled, thereby reducing the calculation workload, preventing the problem of overfitting, and improving the accuracy in causal effect analysis.

The above-described optional technical solutions may construct the optional embodiments of the present disclosure through any combination, which are not described herein any further.

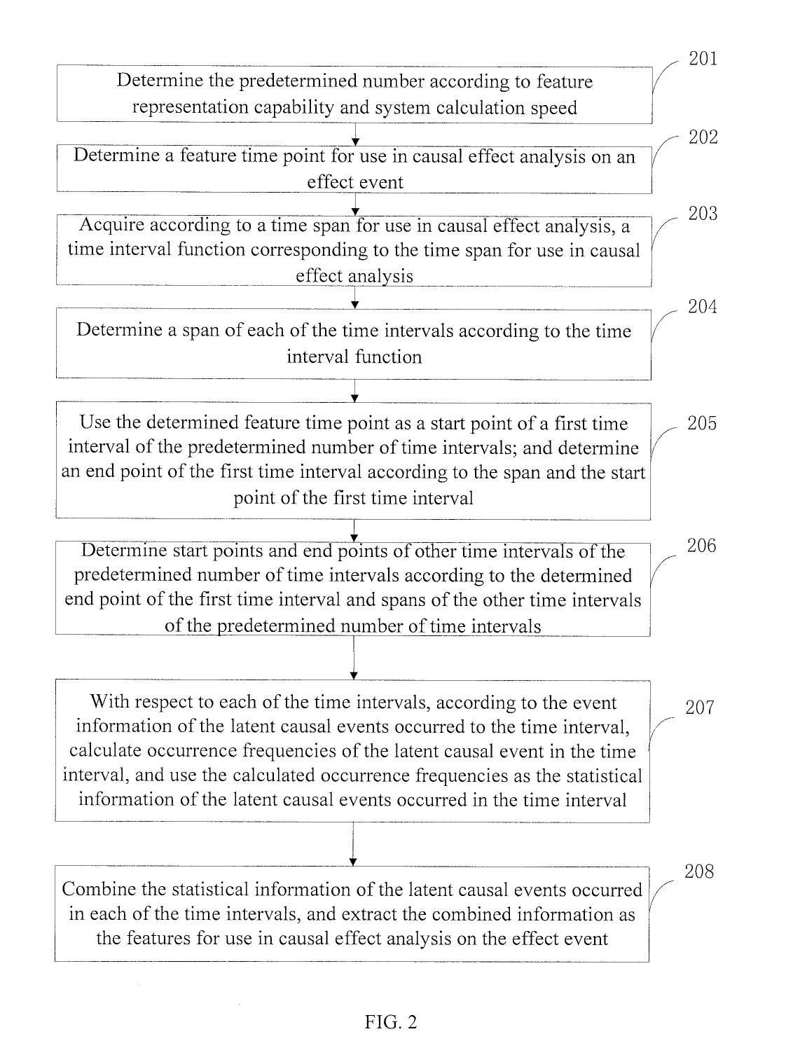

FIG. 2 is a flowchart of a feature extraction method for use in causal effect analysis according to an embodiment of the present disclosure. Referring to FIG. 2, the method includes the following steps:

Step 201: Determining the predetermined number according to feature representation capability and system calculation speed.

In this embodiment, the description is given by using the predetermined number being four (4), as an example.

Step 202: Determining a feature time point for use in causal effect analysis on a resultant event.

In this embodiment, the description is given by using casual effect analysis on a crime rate rise event in cities, as an example, and it is assumed that a feature time point t0 is selected for causal effect analysis on the crime rate rise event in cities.

Step 203: Acquiring, according to a time span for use in causal effect analysis, a time interval function corresponding to the time span for use in causal effect analysis.

In this embodiment, the event information of the potential causal events is recorded by month, and the time span for use in causal effect analysis is about three (3) years. In this case, the description is given by using the time interval function being as an exponential function f(i)=3ⁱ⁻¹, as an example.

Step 204: Determining a span of each of the time intervals according to the time interval function.

Step 205: Using the determined feature time point as a start point of a first time interval of the predetermined number of time intervals; and determining an end point of the first time interval according to the span and the start point of the first time interval.

Step 206: Determining start points and end points of other time intervals of the predetermined number of time intervals according to the determined end point of the first time interval and spans of the other time intervals of the predetermined number of time intervals.

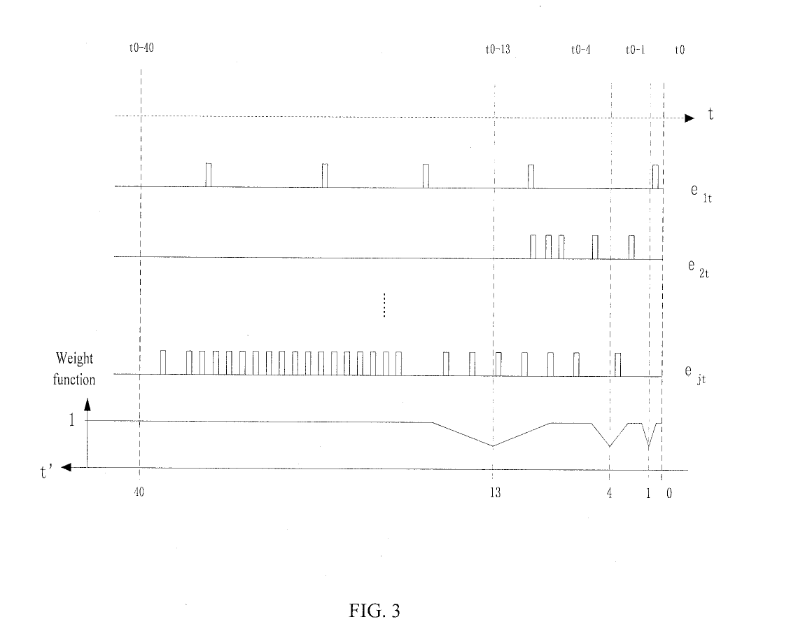

Referring to FIG. 3, the types of the potential causal events are respectively e₁_{ₜ}, e₂_{ₜ}, . . . , eⱼ_{ₜ}, the predetermined number is four (4), and the time interval function is f(i)=3ⁱ⁻¹. In this case, the spans of the four time intervals are respectively 1 month, 3 months, 9 months, and 27 months. Starting from the feature time point t0, each of the time intervals is acquired according to the span of each of the time intervals, and four time intervals (t0-1, t0), (t0-4, t0-1), (t0-13, t0-4), and (t0-4, t0-13) are acquired respectively.

Step 207: With respect to each of the time intervals, according to event information of potential causal events occurred in the time interval, calculating an occurrence frequency of the potential causal events in the time interval, and using the calculated occurrence frequency as the statistical information of the potential causal events occurred in the time interval.

Step 207 is a process of separate calculation for each of the time intervals. With respect to a time interval where multiple types of potential causal events have occurred, each type of potential causal events has corresponding statistical information.

Based on the example in step 204, with respect to a time interval having a span of 3 months, the potential causal event type e₁_{ₜ} in the time interval has an occurrence frequency of 0, the potential causal event type e₂_{ₜ} has an occurrence frequency of ⅓, . . . , and the potential causal event type eⱼ_{ₜ} has an occurrence frequency of ⅓.

Step 208: Combining the statistical information of the potential causal events occurred in each of the time intervals, and extracting the combined information as the features for use in causal effect analysis on the resultant event.

Taking the example of extracting the statistical information of the potential causal events occurred in each of the time interval as a feature vector for use in causal effect analysis on the resultant event, if the statistical information of the potential causal event e₁_{ₜ} in the four time intervals is respectively S11, S12, S13, and S14, the statistical information of the potential causal event e₂_{ₜ} in the four time intervals is respectively S21, S22, S23, and S24, . . . , and the statistical information of the potential causal event eⱼ_{ₜ} in the four time intervals is respectively Sj1, Sj2, Sj3, and Sj4, then the extracted feature vectors are [S11, S12, S13, S14, S21, S22, S23, S24, . . . , Sj1, Sj2, Sj3, Sj4].

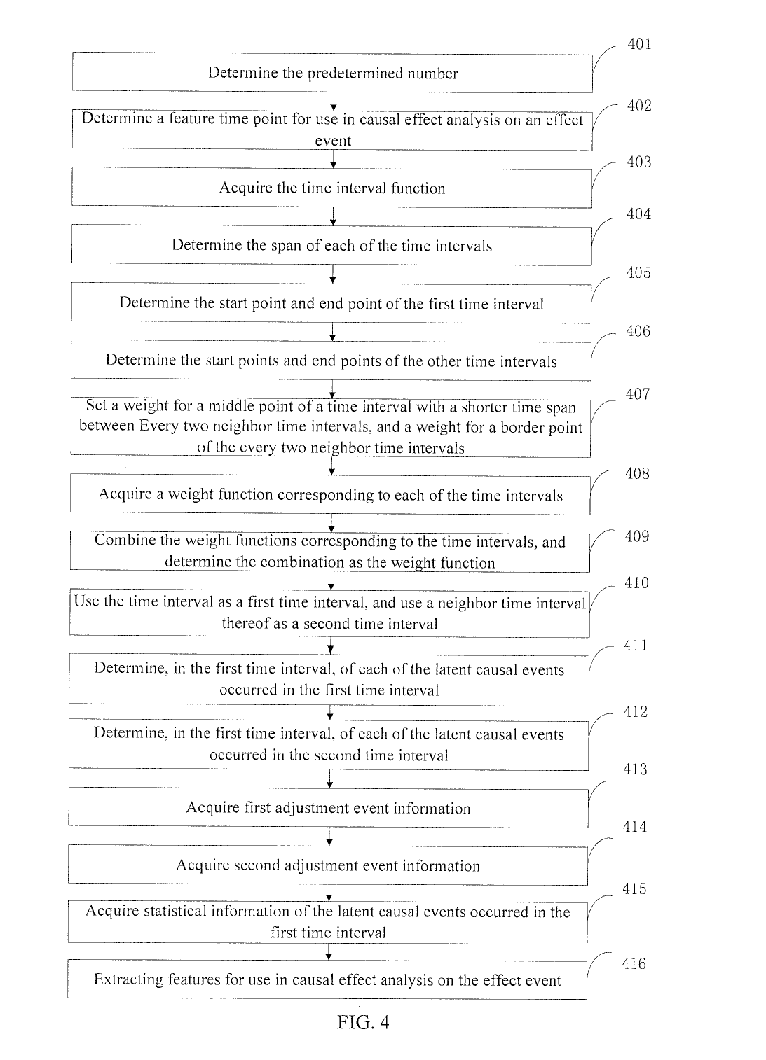

FIG. 4 is a flowchart of a feature extraction method for use in causal effect analysis according to an embodiment of the present disclosure. Referring to FIG. 4, the method includes the following steps:

Step 401: Determining the predetermined number according to feature representation capability and system calculation speed.

In this embodiment, the description is given by using the predetermined number being four (4) as an example.

Step 402: Determining a feature time point for use in causal effect analysis on a resultant event.

In this embodiment, the description is given by using casual effect analysis on a crime rate rise event in cities, as an example, and it is assumed that a feature time point t0 is selected for causal effect analysis on the crime rate rise event in cities.

Step 403: Acquiring, according to a time span for use in causal effect analysis, a time interval function corresponding to the time span for use in causal effect analysis.

In this embodiment, the event information of the potential causal events is recorded by month, and the time span for use in causal effect analysis is about three (3) years. In this case, the description is given by using the time interval function as an exponential function f(i)=3ⁱ⁻¹, as an example.

Step 404: Determining a span of each of the time intervals according to the time interval function.

Step 405: Using the determined feature time point as a start point of a first time interval of the predetermined number of time intervals; and determining an end point of the first time interval according to the span and the start point of the first time interval.

Step 406: Determining start points and end points of other time intervals of the predetermined number of time intervals according to the determined end point of the first time interval and spans of the other time intervals of the predetermined number of time intervals.

Step 407: According to the span of each of the time intervals, setting a weight for a middle point of a time interval with a shorter time span between every two neighbor time intervals, and a weight for a border point of every two neighbor time intervals.

In this embodiment, with respect to the third time interval (t0-13, t0-4) starting from the feature time point, as compared with the second time interval neighboring thereto, the second time interval (t0-4, t0-1) has a small span, then the weight of the time point t0-2.5 is set to 1, the weight of the time point t0-4 is set to 0.5, and the weight of the time point t0-5.5 is set to 1. Based on these settings, a linear interpolation is performed for the weights of the time points between the time points t0-5.5 to t0-2.5 to acquire the weight functions of the third time interval and the second time interval, such that a weight function g(t′) corresponding to each of the time intervals is acquired, as illustrated in FIG. 3. It should be noted that the weight function g(t′) in this embodiment uses the time point t0 as the zero point, and uses a direction reverse to the progress of the time as the X coordinate.

Step 408: Acquiring a weight function corresponding to each of the time intervals according to the middle point, the border point, the weight of the middle point, and the weight of the border point.

Step 409: Combining the weight functions corresponding to the time intervals, and determining the combination as the weight function.

Step 410: With respect to a time interval, using the time interval as a first time interval, and using a neighbor time interval as a second time interval.

Step 411: Determining a weight, in the first time interval, of each of the potential causal events occurred in the first time interval according to a weight function.

With respect to the third time interval, a first weight of the potential causal event eⱼ_{ₜ} occurred in the third time interval may be determined according to the weight function g(t′), i.e., g(6.5)=1, g(8.5)=1, g(10.5)=0.78, g(12.5)=0.56.

Step 412: With respect to the second time interval, determining a weight, in the first time interval, of each of the potential causal events occurred in the second time interval according to the weight function.

Referring to FIG. 3, the neighbor time intervals of the third time interval is the second time interval and the fourth time interval, and the curve in the lowest part of FIG. 3 denotes a weight function curve. With respect to the second time interval, the weight, in the second time interval, of the potential causal event eⱼ_{ₜ} occurred in the second time interval may be determined according to the weight function g(t′), i.e., g(3.5)=0.67, and the weight, in the third time interval, of the potential causal event eⱼ_{ₜ} occurred in the second time interval is 1−g(3.5)=0.33. With respect to the fourth time interval, the weight, in the fourth time interval, of the potential causal event eⱼ_{ₜ} occurred in the fourth time interval may be determined according to the weight function g(t′), i.e., g(14.5)=0.67, g(16.5)=0.89, and the weight, in the third time interval, of the potential causal event occurred in the fourth time interval is 1−g(14.5)=0.33, 1−g(16.5)=0.11.

Step 413: Performing weight calculation to acquire first adjustment event information of each of the potential causal events occurred in the first time interval according to the event information of each of the potential causal events occurred in the first time interval and the weight, in the first time interval, of each of the potential causal events occurred in the first time interval.

Step 414: Performing weight calculation to acquire second adjustment event information, in the first time interval, of each of the potential causal events occurred in the second time interval according to the event information of each of the potential causal events occurred in the second time interval and the weight, in the first time interval, of each of the potential causal events occurred in the second time interval.

Step 415: Acquiring the statistical information of the potential causal events occurred in the first time interval according to the first adjustment event information of each of the potential causal events occurred in the first time interval and the second adjustment event information, in the first time interval, of each of the potential causal events occurred in the second time interval.

Using the example where the event information of the potential causal events occurred in the time interval is all one (1), and the statistical information thereof is the redefinition frequency of the potential causal event eⱼ_{ₜ}, an acquired sum of the weights of the event information in the third time interval is:

(1−g(3.5))+g(6.5)+g(8.5)+g(10.5)+g(12.5)+(1−g(14.5))+(1−g(16.5))=4.11; therefore the redefinition frequency of the potential causal events in the third time interval is 4.11/f(3)=0.46.

Step 416: Combining the statistical information of the potential causal events occurred in each of the time intervals, and extracting the combined information as the features for use in causal effect analysis on the resultant event.

Using the example of extracting the statistical information of the potential causal events occurred in each of the time interval as a feature vector for use in causal effect analysis on the resultant event, if the statistical information of the potential causal event e₁_{ₜ} in the four time intervals is respectively S11, S12, S13, and S14, the statistical information of the potential causal event e₂_{ₜ} in the four time intervals is respectively S21, S22, S23, and S24, . . . , and the statistical information of the potential causal event eⱼ_{ₜ} in the four time intervals is respectively Sj1, Sj2, Sj3, and Sj4, then the extracted feature vectors are [S11, S12, S13, S14, S21, S22, S23, S24, . . . , Sj1, Sj2, Sj3, Sj4].

According to the method provided in this embodiment, time intervals having different spans are acquired, statistical information of each time interval is acquired, the statistical information of the each time interval is extracted as a feature for use in causal effect analysis, such that, comprehensively considering the short-period potential causal event and the long-period potential causal event, the number of extracted features is controlled, thereby reducing the calculation workload, preventing the problem of overfitting, and improving accuracy in causal effect analysis. Further, by means of weight allocation, the border effect of the features is weakened, and the accuracy in causal effect analysis is improved.

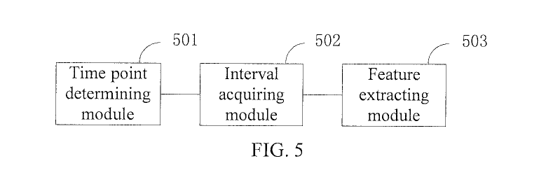

FIG. 5 is a schematic diagram of structure of a feature extraction apparatus for use in causal effect analysis according to an embodiment of the present disclosure. Referring to FIG. 5, the apparatus includes: a time point determining module 501, an interval acquiring module 502, and a feature extracting module 503.

The time point determining module 501 is configured to determine a feature time point for use in causal effect analysis on a resultant event. The interval acquiring module 502 is connected to the time point determining module 501, and is configured to acquire a predetermined number of time intervals according to the determined feature time point, where the predetermined number of time intervals are prior to the determined feature time point, and the interval length from the time interval to the determined feature time point is in positive correlation to the span of the time interval. The feature extracting module 503 is connected to the interval acquiring module 502, and is configured to extract features for use in causal effect analysis on the resultant event according to event information of potential causal events occurred in each of the time intervals.

Optionally, the interval acquiring module 502 includes:

a function acquiring unit, configured to acquire, according to a time span for use in causal effect analysis, a time interval function corresponding to the time span for use in causal effect analysis;

a span determining unit, configured to determine a span of each of the time intervals according to the time interval function;

a first determining unit, configured to: use the determined feature time point as a start point of a first time interval of the predetermined number of time intervals, and determine an end point of the first time interval according to the span and the start point of the first time interval; and

a second determining unit, configured to determine start points and end points of other time intervals according to the determined end point of the first time interval and spans of the other time intervals of the predetermined number of time intervals.

Optionally, the feature extracting module 503 includes:

a statistical information acquiring unit, configured to acquire statistical information of the potential causal events occurred in each of the time intervals according to the event information of the potential causal events occurred in each of the time intervals; and

a feature extracting unit, configured to extract features for use in causal effect analysis on the resultant event according to the statistical information of the potential causal events occurred in each of the time intervals.

Optionally, the statistical information acquiring unit is configured to, with respect to a time interval, calculate an occurrence frequency of the potential causal events in the time interval, and use the occurrence frequency as the statistical information of the potential causal events occurred in the time interval.

Optionally, the statistical information acquiring unit is configured to, with respect to a time interval, calculate an average value of the event information of the potential causal events occurred in the time interval, and use the average value as the statistical information of the potential causal events occurred in the time interval.

Optionally, the statistical information acquiring unit is configured to, with respect to a time interval, calculate a standard deviation of the event information of the potential causal events occurred in the time interval, and use the standard deviation as the statistical information of the potential causal events occurred in the time interval.

Optionally, the statistical information acquiring unit includes:

a time interval distinguishing subunit, configured to, with respect to a time interval, use the time interval as a first time interval, and use a neighbor time interval as a second time interval;

a first weight determining subunit, configured to determine a weight in the first time interval, of each of the potential causal events occurred in the first time interval according to a weight function;

a second weight determining subunit, configured to determine a weight in the first time interval, of each of the potential causal events occurred in the second time interval according to the weight function;

a first adjusting subunit, configured to: perform weight calculation to acquire first adjustment event information of each of the potential causal events in the first time interval according to the event information of each of the potential causal events occurred in the first time interval and the weight, in the first time interval, of each of the potential causal events occurred in the first time interval;

a second adjusting subunit, configured to: perform weight calculation to acquire second adjustment event information, in the first time interval, of each of the potential causal events in the second time interval according to the event information of each of the potential causal events occurred in the second time interval, and the weight, in the first time interval, of each of the potential causal events occurred in the second time interval; and

a statistical information acquiring subunit, configured to acquire the statistical information of the potential causal events occurred in the first time interval according to the first adjustment event information of each of the potential causal events occurred in the first time interval, and the second adjustment event information, in the first time interval, of each of the potential causal events occurred in the second time interval.

Optionally, the statistical information acquiring subunit is configured to calculate, according to the first adjustment event information and the second adjustment event information, a redefinition frequency of each of the potential causal events occurred in the first time interval, and use the redefinition frequency as the statistical information of the potential causal events occurred in the first time interval.

Optionally, the statistical information acquiring subunit is configured to calculate an average value of the first adjustment event information of each of the potential causal events occurred in the first time interval and the second adjustment event information, in the first time interval, of each of the potential causal events occurred in the second time interval, and use the calculated average value as the statistical information of the potential causal events occurred in the first time interval.

Optionally, the statistical information acquiring subunit is configured to calculate a standard deviation of the first adjustment event information of each of the potential causal events occurred in the first time interval and the second adjustment event information, in the first time interval, of each of the potential causal events occurred in the second time interval, and use the calculated standard deviation as the statistical information of the potential causal events occurred in the first time interval.

Optionally, the apparatus further includes:

a weight setting module, configured to: set a weight for the middle point of a time interval with a shorter time span between every two neighbor time intervals, and a weight for a border point of the every two neighbor time intervals according to the span of each of the time intervals;

a function acquiring module, configured to acquire a weight function corresponding to each of the time intervals according to the middle point, the border point, the weight of the middle point, and the weight of the border point; and

a function determining module, configured to combine the weight functions corresponding to the time intervals, and determine the combination as the weight function.

Optionally, the feature extracting unit is configured to extract features for use in causal effect analysis on the resultant event according to the statistical information of the potential causal events occurred in each of the time intervals; or

the feature extracting unit is configured to combine the statistical information of the potential causal event occurred in each of the time intervals, and extract the combined information as the features for use in causal effect analysis on the resultant event.

Optionally, the apparatus further includes:

a predetermined number determining module, configured to determine the predetermined number according to feature representation capability and system calculation speed.

According to the apparatus provided in this embodiment, time intervals having different spans are acquired, statistical information of each of the time intervals is acquired, the statistical information of each of the time intervals is extracted as a feature for use in causal effect analysis, such that, comprehensively considering the short-period potential causal event and the long-period potential causal event, the number of extracted features is controlled, thereby reducing the calculation workload, preventing the problem of overfitting, and improving accuracy in causal effect analysis. Further, by means of weight allocation, the border effect of the features is weakened, and the accuracy in causal effect analysis is improved.

It should be noted that, during extraction of features for use in causal effect analysis, the feature extraction apparatus, according to the above embodiments, is described as only using division of the above functional modules for example. In practice, the functions may be assigned to different functional modules for implementations as required. That is, the internal structure of the apparatus is divided into different functional modules to implement all or a part of the above-described functions. In addition, the feature extraction apparatus for use in causal effect analysis provided in the above embodiment is based on the same inventive concept as the feature extraction method for use in causal effect analysis. For the specific implementation thereof, please refer to the method embodiment, which is not detailed herein any further.

Persons of ordinary skill in the art should understand that all or a part of steps of the preceding methods may be implemented by hardware or programs instructing relevant hardware. The programs may be stored in a computer-readable storage medium. The storage medium may be a read only memory, a magnetic disk, or an optical disk.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A feature extraction method for use in causal effect analysis, comprising:
determining a feature time point for use in causal effect analysis on a resultant event;
acquiring a predetermined number of time intervals according to the determined feature time point, wherein the predetermined number of time intervals are prior to the determined feature time point, and an interval length from a time interval to the determined feature time point is in positive correlation to a span of the time interval; and
extracting features for use in causal effect analysis on the resultant event according to event information of potential causal events occurred in each of the predetermined number of time intervals.

2. The method according to claim 1, wherein acquiring the predetermined number of time intervals according to the determined feature time point comprises:
acquiring, according to a time span for use in causal effect analysis, a time interval function corresponding to the time span for use in causal effect analysis;
determining a span of each of the time intervals according to the time interval function;
using the determined feature time point as a start point of a first time interval of the predetermined number of time intervals;
determining an end point of the first time interval according to the span and the start point of the first time interval; and
determining start points and end points of other time intervals of the predetermined number of time intervals according to the determined end point of the first time interval and spans of the other time intervals of the predetermined number of time intervals.

3. The method according to claim 1, wherein extracting features for use in causal effect analysis on the resultant event according to event information of potential causal events occurred in each of the time intervals comprises:
acquiring statistical information of the potential causal events occurred in each of the time intervals according to the event information of the potential causal events occurred in each of the time intervals; and
extracting the features for use in causal effect analysis on the resultant event according to the statistical information of the potential causal events occurred in each of the time intervals.

4. The method according to claim 3, wherein acquiring statistical information of the potential causal events occurred in each of the time intervals according to the event information of the potential causal events occurred in each of the time intervals comprises:
with respect to a time interval, calculating an occurrence frequency of the potential causal events occurred in the time interval, and using the occurrence frequency as the statistical information of the potential causal events occurred in the time interval.

5. The method according to claim 3, wherein acquiring statistical information of the potential causal events occurred in each of the time intervals according to the event information of the potential causal events occurred in each of the time intervals comprises:
with respect to a time interval, calculating an average value of the event information of the potential causal events occurred in the time interval, and using the average value as the statistical information of the potential causal events occurred in the time interval.

6. The method according to claim 3, wherein acquiring statistical information of the potential causal events occurred in each of the time intervals according to the event information of the potential causal events occurred in each of the time intervals further comprises:
with respect to a time interval, calculating a standard deviation of the event information of the potential causal events occurred in the time interval, and using the standard deviation as the statistical information of the potential causal events occurred in the time interval.

7. The method according to claim 3, wherein acquiring statistical information of the potential causal events occurred in each of the time intervals according to the event information of the potential causal events occurred in each of the time intervals further comprises:
with respect to a time interval, using the time interval as a first time interval, and using a neighbor time interval of the first time interval as a second time interval;
determining a weight, in the first time interval, of each of the potential causal events occurred in the first time interval according to a weight function;
with respect to the second time interval, determining a weight, in the first time interval, of each of the potential causal events occurred in the second time interval according to the weight function;
according to the event information of each of the potential causal events occurred in the first time interval and the weight, in the first time interval, of each of the potential causal events occurred in the first time interval, performing a weight calculation to acquire first adjustment event information of each of the potential causal events occurred in the time interval;
according to the event information of each of the potential causal events occurred in the second time interval and the weight, in the first time interval, of each of the potential causal events occurred in the second time interval, performing a weight calculation to acquire second adjustment event information, in the first time interval, of each of the potential causal events occurred in the second time interval; and
acquiring the statistical information of the potential causal events occurred in the first time interval according to the first adjustment event information of each of the potential causal events occurred in the first time interval and the second adjustment event information, in the first time interval, of each of the potential causal events occurred in the second time interval.

8. The method according to claim 7, wherein acquiring the statistical information of the potential causal events occurred in the first time interval according to the first adjustment event information of each of the potential causal events occurred in the first time interval and the second adjustment event information, in the first time interval, of each of the potential causal events occurred in the second time interval comprises:
according to the first adjustment event information and the second adjustment event information, calculating a redefinition frequency of each of the potential causal events occurred in the first time interval, and using the redefinition frequency as the statistical information of the potential causal events occurred in the first time interval.

9. The method according to claim 7, wherein acquiring the statistical information of the potential causal events occurred in the first time interval according to the first adjustment event information of each of the potential causal events occurred in the first time interval and the second adjustment event information, in the first time interval, of each of the potential causal events occurred in the second time interval further comprises:
calculating an average value of the first adjustment event information of each of the potential causal events occurred in the first time interval and the second adjustment event information, in the first time interval, of each of the potential causal events occurred in the second time interval, and using the calculated average value as the statistical information of the potential causal events occurred in the first time interval.

10. The method according to claim 7, wherein acquiring the statistical information of the potential causal events occurred in the first time interval according to the first adjustment event information of each of the potential causal events occurred in the first time interval and the second adjustment event information, in the first time interval, of each of the potential causal events occurred in the second time interval further comprises:
calculating a standard deviation of the first adjustment event information of each of the potential causal events occurred in the first time interval and the second adjustment event information, in the first time interval, of each of the potential causal events occurred in the second time interval, and using the calculated standard deviation as the statistical information of the potential causal events occurred in the first time interval.

11. The method according to claim 7, further comprising:
according to the span of each of the time intervals, setting a weight for a middle point of a time interval with a shorter time span between every two neighbor time intervals, and a weight for a border point of the every two neighbor time intervals;
acquiring a weight function corresponding to each of the time intervals according to the middle point, the border point, the weight of the middle point, and the weight of the border point; and
combining the weight functions corresponding to all the time intervals, and determining the combination as the weight function.

12. The method according to claim 3, wherein extracting features for use in causal effect analysis on the resultant event according to the statistical information of the potential causal events occurred in each of the time intervals comprises:
extracting the statistical information of the potential causal event occurred in each of the time intervals as the features for use in causal effect analysis on the resultant event; or
combining the statistical information of the potential causal events occurred in each of the time intervals, and extracting the combined information as the features for use in causal effect analysis on the resultant event.

13. The method according to claim 1, wherein prior to acquiring a predetermined number of time intervals according to the determined feature time point, the method further comprises:
determining the predetermined number according to a feature representation capability and a system calculation speed.

14. A feature extraction apparatus for use in causal effect analysis, comprising:
a time point determining module, configured to determine a feature time point for use in causal effect analysis on a resultant event;
an interval acquiring module, configured to acquire a predetermined number of time intervals according to the determined feature time point, wherein the predetermined number of time intervals are prior to the determined feature time point, and an interval length from a time interval to the determined feature time point is in positive correlation to a span of the time interval; and
a feature extracting module, configured to extract features for use in causal effect analysis on the resultant event according to event information of potential causal events occurred in each of the predetermined number of time intervals.

15. The apparatus according to claim 14, wherein the interval acquiring module comprises:
a function acquiring unit, configured to acquire, according to a time span for use in causal effect analysis, a time interval function corresponding to the time span for use in causal effect analysis;
a span determining unit, configured to determine a span of each of the time intervals according to the time interval function;
a first determining unit, configured to use the determined feature time point as a start point of a first time interval of the predetermined number of time intervals, and determine an end point of the first time interval according to the span and the start point of the first time interval; and
a second determining unit, configured to determine start points and end points of other time intervals according to the determined end point of the first time interval and spans of the other time intervals of the predetermined number of time intervals.

16. The apparatus according to claim 14, wherein the feature extracting module further comprises:
a statistical information acquiring unit, configured to acquire statistical information of the potential causal events occurred in each of the time intervals according to the event information of the potential causal events occurred in each of the time intervals; and
a feature extracting unit, configured to extract features for use in causal effect analysis on the resultant event according to the statistical information of the potential causal events occurred in each of the time intervals.

17. The apparatus according to claim 16, wherein the statistical information acquiring unit is further configured to, with respect to a time interval, calculate an occurrence frequency of the potential causal events occurred in the time interval, and use the occurrence frequency as the statistical information of the potential causal events occurred in the time interval.

18. The apparatus according to claim 16, wherein the statistical information acquiring unit is further configured to, with respect to a time interval, calculate an average value of the event information of the potential causal events occurred in the time interval, and use the average value as the statistical information of the potential causal events occurred in the time interval.

19. The apparatus according to claim 16, wherein the statistical information acquiring unit is further configured to, with respect to a time interval, calculate a standard deviation of the event information of the potential causal events occurred in the time interval, and use the standard deviation as the statistical information of the potential causal events occurred in the time interval.

20. The apparatus according to claim 16, wherein the statistical information acquiring unit comprises:
a time interval distinguishing subunit, configured to, with respect to a time interval, use the time interval as a first time interval, and use a neighbor time interval of the first time interval as a second time interval;
a first weight determining subunit, configured to, determine a weight, in the first time interval, of each of the potential causal events occurred in the first time interval according to a weight function;
a second weight determining subunit, configured to, determine a weight, in the first time interval, of each of the potential causal events occurred in the second time interval according to the weight function;
a first adjusting subunit, configured to: perform a weight calculation to acquire first adjustment event information of each of the potential causal events occurred in the first time interval according to the event information of each of the potential causal events occurred in the first time interval and the weight, in the first time interval, of each of the potential causal events occurred in the first time interval;
a second adjusting subunit, configured to: perform a weight calculation to acquire second adjustment event information, in the first time interval, of each of the potential causal events occurred in the second time interval according to the event information of each of the potential causal events occurred in the second time interval, and the weight, in the first time interval, of each of the potential causal events occurred in the second time interval; and
a statistical information acquiring subunit, configured to acquire the statistical information of the potential causal events occurred in the first time interval according to the first adjustment event information of each of the potential causal events occurred in the first time interval and the second adjustment event information, in the first time interval, of each of the potential causal events occurred in the second time interval.

21. The apparatus according to claim 20, wherein the statistical information acquiring subunit is further configured to calculate, according to the first adjustment event information and the second adjustment event information, an redefinition frequency of each of the potential causal events occurred in the first time interval, and use the redefinition frequency as the statistical information of the potential causal events occurred in the first time interval.

22. The apparatus according to claim 20, wherein the statistical information acquiring subunit is further configured to calculate an average value of the first adjustment event information of each of the potential causal events occurred in the first time interval and the second adjustment event information, in the first time interval, of each of the potential causal events occurred in the second time interval, and use the calculated average value as the statistical information of the potential causal events occurred in the first time interval.

23. The apparatus according to claim 20, wherein the statistical information acquiring subunit is further configured to calculate a standard deviation of the first adjustment event information of each of the potential causal events occurred in the first time interval and the second adjustment event information, in the first time interval, of each of the potential causal events occurred in the second time interval, and use the calculated standard deviation as the statistical information of the potential causal events occurred in the first time interval.

24. The apparatus according to claim 20, further comprising:
a weight setting module, configured to: set a weight for the middle point of a time interval with a shorter time span between every two neighbor time intervals, and a weight for a border point of the every two neighbor time intervals according to the span of each of the time intervals;
a function acquiring module, configured to acquire a weight function corresponding to each of the time intervals according to the middle point, the border point, the weight of the middle point, and the weight of the border point; and
a function determining module, configured to combine the weight functions corresponding to all the time intervals, and determine the combination as the weight function.

25. The apparatus according to claim 16, wherein the feature extracting unit is configured to extract the statistical information of the potential causal events occurred in each of the time intervals as the features for use in causal effect analysis on the resultant event; or
the feature extracting unit is configured to combine the statistical information of the potential causal event occurred in each of the time intervals, and extract the combined information as the features for use in causal effect analysis on the resultant event.

26. The apparatus according to claim 14, further comprising:
a predetermined number determining module, configured to determine the predetermined number according to a feature representation capability and a system calculation speed.
